(19) United States
(12) Patent Application Publication
(10) Pub. No.: US 2018/0111691 A1
(43) Pub. Date: Apr. 26, 2018

(54) AIRCRAFT TRAY TABLE

(71) Applicant: Molon Labe LLC, Breckenridge, CO (US)

(72) Inventors: Kevin Lee Van Liere, Louisville, CO (US); Frank Matthew Scott, Breckenridge, CO (US)

(21) Appl. No.: 15/784,964

(22) Filed: Oct. 16, 2017

Related U.S. Application Data
(60) Provisional application No. 62/410,508, filed on Oct. 20, 2016.

(51) Int. Cl. B64D 11/06; F16B 12/02

(52) U.S. Cl. CPC B64D 11/0638; F16B 12/02

(57) ABSTRACT

A locking device for a deployable tray table disposed on a rearward surface of a passenger seatback is disclosed. The locking device may be incorporated into a hinge or knuckle of the tray table such that the tray table may be retained in a stowed configuration without a latch mechanism disposed along a top edge of the stowed tray table. In some embodiments, a support arm of the tray table may terminate with a plurality of narrow fingers, each having an elongated slot configured to receive an axel pin disposed within the knuckle.

### CROSS REFERENCE

The present application claims the benefit of the fling date of U.S. Provisional Application No. 62/410,508 having the filing date of Oct. 20, 2016, the entire contents of which are incorporated herein by reference.

### FIELD

The present disclosure is directed to a locking device for a deployable tray table, for example, disposed in a rearward surface of a passenger seatback. The locking device may be incorporated into a hinge or knuckle of the device.

### BACKGROUND

Many passenger seats, such as those on aircraft, buses, trains, and the like, are arranged so that each passenger seat faces the back of the next passenger seat forward, with the exception of the first row of seats. In some instances, a tray table is mounted to the back of each passenger seat for use by a passenger seated directly to the rear of the tray table. The tray table may be deployed by the passenger to provide a substantially flat working surface for eating, working, recreation, or other uses.

Currently, many tray tables used in passenger vehicles are secured by a pivoting latch mechanism disposed near an uppermost edge of the tray table when the table is in a stowed (e.g., upright and locked) configuration. However, often times such latch mechanisms exhibit wear and fail to properly secure the tray table, thus requiring maintenance, raising safety concerns, and/or creating nuisance for passengers. Even in the absence of wear and tear, the movement of passengers into and out of rows of seats frequently results in passengers unintentionally brushing against such latch mechanisms, thereby dropping tray tables into a deployed (e.g., horizontal) configuration. Such unintentional and abrupt deployment may startle passengers, block pathways, and damage tray table arms and hinges.

In light of the above, it is desirable to provide a tray table design that does not rely on a pivoting latch mechanism for securement to, inter alia, improve safety and reduce maintenance costs.

### SUMMARY

Aspects of the presented inventions are directed to a tray table assembly that may be utilized with passenger seating. In one application, the tray table assembly may be attached to the back/aft surface of an aircraft seat, though it will be appreciated that the tray table assembly may be utilized with other passenger seating as well. The tray table may pivot between a stowed configuration, in which a working surface of the tray table (i.e., the usable table top surface) is disposed relative to a seatback, and a deployed configuration providing a substantially horizontal working surface for passenger use. The pivotal movement of the tray table may be provided by first and second brackets/knuckles (e.g., hinges) that connect the tray table to the forward seat (e.g., seatback, armrest, frame, etc.). In addition to providing pivotal movement for the tray, one or both knuckles may provide a locking mechanism for maintaining the tray table in the stowed position. In this regard, no separate latch mechanism may be required for securing the tray table.

In one arrangement, a tray table assembly is adapted for use with a rearward surface of a seatback of a passenger vehicle such as, for example, an aircraft seat. The assembly includes a tray table having a generally planar surface. While being described as a generally planar surface, it will be appreciated that the tray table may include variations such as, for example, a raised lip around its peripheral surface, cup holder indentations, etc. Further, the tray table is not limited to any particular peripheral shape. At least one and more commonly two support arms are secured to the tray table. The support arms each have a free end that extends beyond an edge of the tray table. The free end of each support arm includes an elongated aperture extending there through. Mating brackets or knuckles are configured for attachment to the rearward or aft surface of the passenger seat. The free ends of the support arms are received within slots formed within the brackets. An axel pin extends across the bracket slot and through the elongated aperture on the free end of the support arms. The axel pin(s) permits the support arm to rotate between a stowed configuration, where the attached tray table is in a generally vertical orientation, and deployed position where the attached tray table is in a generally horizontal orientation. In the generally vertical orientation, the axel pin may be disposed at rearward end of the elongated aperture. Such positioning of the axel pin disposes a terminal end of the support arm into an interior of the bracket. This axial insertion into the bracket prevents rotation of the support arm and the supported tray table from the generally vertical orientation to the generally horizontal orientation. In the generally vertical orientation, the weight of the tray table assembly maintains the terminal end of the support arm within the bracket. Stated otherwise, gravity maintains the tray table in the stowed configuration. In order to move the tray table from the stowed configuration to the deployed configuration, a user lifts the tray table and/or support arm to partially retract the free end of the support arm from the interior of the bracket. This permits the axel pin to move to a forward portion of the elongated aperture and thereby permits rotation of the support arm and attached tray table around the axel pin to the deployed position.

### BRIEF DESCRIPTION OF THE FIGURES

FIG. 1 illustrates a rear view of an embodiment of a tray table disposed upon a passenger seat in accordance with the presented inventions.

FIGS. 2A-2D illustrate right-side views of the embodiment of a tray table in various positions ranging between the stowed and deployed configurations.

FIGS. 3A-3B illustrate enlarged right-side views of the embodiment of tray table in various positions.

FIG. 4 illustrates a view of a tray table assembly and knuckle.

FIG. 5A shows a perspective view of the knuckle.

FIG. 5B illustrates a front view of the knuckle.

FIG. 5C illustrates a partial cutaway of the knuckle.

FIGS. 6A-6C illustrate enlarged right-side views of the embodiment of a tray table in various positions with certain components removed to reveal internal components of a knuckle.

FIG. 6D illustrates a close up view of a portion of FIG. 6A.

### DETAILED DESCRIPTION

Reference will now be made to the accompanying drawings, which at least assist in illustrating various pertinent features of the presented inventions. The following description is presented for purposes of illustration and description and is not intended to limit the inventions to the forms disclosed herein. Consequently, variations and modifications commensurate with the following teachings, and skill and knowledge of the relevant art, are within the scope of the presented inventions. The embodiments described herein are further intended to explain the best modes known of practicing the inventions and to enable others skilled in the art to utilize the inventions in such, or other, embodiments and with various modifications required by the particular application(s) or use(s) of the presented inventions.

Certain directional words are used herein for convenience in establishing orientation. The terms “rearward” and “forward” may generally be understood to reference the passenger vehicle in which the tray table is disposed. For example, a rearward element should be understood as being disposed closer to the rear of the passenger vehicle (e.g., aircraft) than a forward element. The term “vertical,” as used herein, may generally be understood as referring to an axis extending generally perpendicular to a floor of the passenger vehicle. In this regard, a “vertical” element may be generally perpendicular to a floor of the passenger vehicle and/or parallel to a respective seatback despite the seatback being disposed in a reclined configuration. The term “horizontal” may generally refer to a position which is generally parallel to a floor of the passenger vehicle. In this regard, an element may be considered “horizontal” if it is substantially parallel to the floor even though the floor might not be parallel to the horizon.

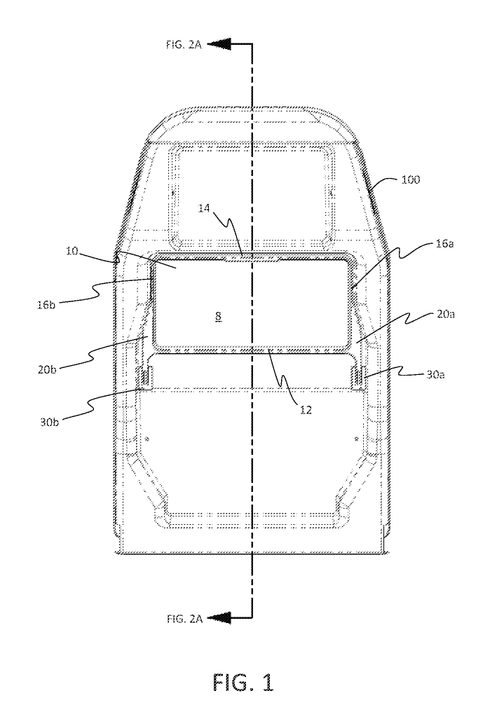

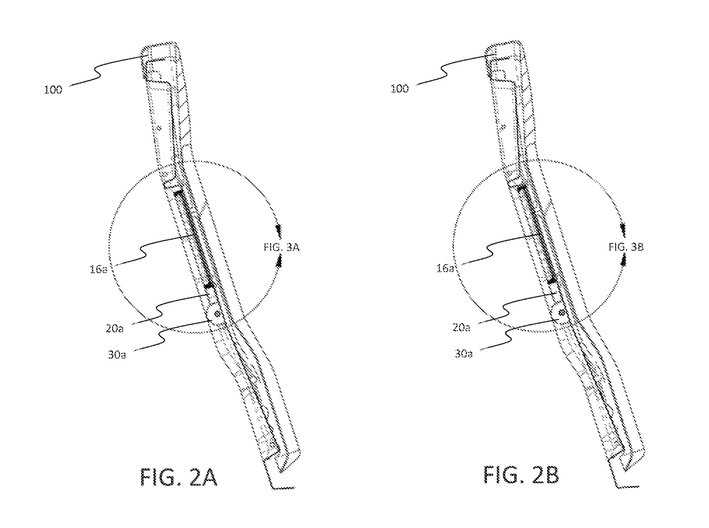

FIG. 1 provides a rear view of a passenger seat having a tray table in accordance with the presented inventions. In the illustrated embodiment, tray table 10 is disposed in a stowed configuration in a recessed area of a rearward or aft surface (e.g., back) of a passenger seat 100. Such positioning within the back of the seat 100 permits the tray table 10 to be completely removed from passenger seating space of a passenger seat disposed behind the seat 100 when not in use. However, it will be appreciated that a seatback recess is not required and the tray table 10 may rest against or near a rear surface of a seat in the stowed configuration. As shown, the body of the tray table 10 is a generally planar element 8 having a forward edge 12 and a rearward edge 14, as well as opposing side edges 16a, 16b (hereafter ‘16’ unless specifically referenced). In other embodiments, the body of the tray table 10 may have a different shape and may include additional working surface features such as recessed cup holders, apertures and/or elements for use in securing passenger items (e.g., laptops, phones, pens, food containers, etc.) to the working surface of the table. The side edges 16 include a pair of support arms 20a, 20b (hereafter ‘20’ unless specifically referenced), which pivotally attach the body of the tray table to a pair of mating brackets or knuckles 30a, 30b (hereafter ‘30’ unless specifically referenced). The knuckles 30 may be any pivoting or hinge device that provides the functionality described herein. In one arrangement, the tray table 10 and support arms 20 may be an integrally formed unit. For example, they may be molded with plastic as one unit or may be constructed as a singular metallic (e.g., aluminum, steel, titanium, alloy, etc.) unit. However, it will be appreciated in other embodiments these elements may be separately formed and attached with any appropriate fastening means. The knuckles 30 permit the tray table 10 to move between the stowed configurations to the deployed configuration (as shown in FIGS. 2A-2D).

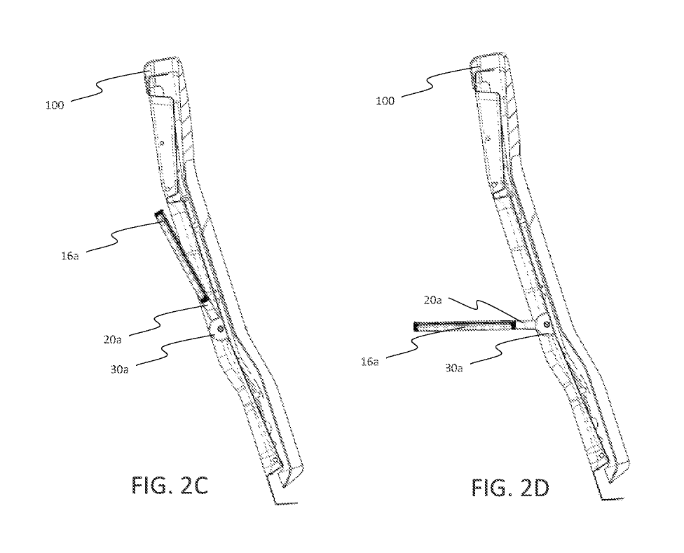

Turning to FIGS. 2A-3B, in addition to permitting the tray table to move between the stowed and deployed configurations, the knuckles 30 also provide a locking mechanism that maintains the tray table in the stowed configuration when not in use. Initially, when the tray table 10 is in the stowed configuration as shown in FIGS. 2A and 3A, each support arm 20 is disposed in a downward position as shown by the arrow in FIG. 3A. In this arrangement, the free ends of the support arms are inserted into their respective knuckle along an axis extending generally from the top of the seatback to the bottom of the seatback passing through the knuckle 30. As is more fully discussed below, this positioning prevents rotation of the support arms 20 around a rotational axis extending through axel pins 32 of each knuckle 30, thereby locking the tray 10 in the stowed configuration. Of note, the weight of the tray table 10 and support arms 20 maintain the free ends of the support arms within the knuckles 30. That is, gravity is utilized to lock the try table in the stowed position. When the support arms 20 are axially inserted into the knuckles 30 as described above, the rearward edge 14 of the table 10 is spaced a distance d from a top edge of the recess within the seat 100 as shown in FIG. 3A. To lower the tray table 10 into the deployed configuration, a user engages the tray table 10 (e.g., engages a recessed bottom surface or rim 18 of the table with their fingers) and lifts the tray table 10 upward to the position illustrated in FIGS. 2B and 3B. This axially advances the free ends of the support arms 20 from an advanced position within the interior of the knuckles 30 to a retracted position within the knuckles, which frees the support arms 20 to rotate about the rotational axis through the axel pins 32. As shown in FIG. 3B, lifting of the tray table 10 in the direction of the arrow advances the rearward edge 14 of the tray table 10 proximate to the top edge of the recess in the seatback leaving a spacing of d′, which is less than d. This advancement frees the tray table 10 from being bound by the knuckles 30, allowing its deployment as illustrated in FIGS. 2C and 2D.

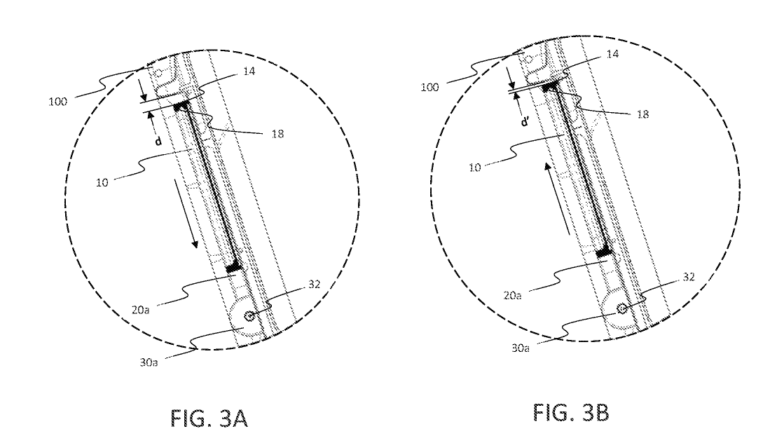

FIG. 4 illustrates the tray table 10 and one of the knuckles 30. As shown, each support arm 20 is attached to a side surface 16 of the tray table and includes a free end portion 21 that extends beyond the forward edge 12 of the tray table. In the present embodiment, each free end portion 21 terminates in a furcated end that mates with one of the knuckles 30 (only one shown). That is, each free end portion 21 of the support arms 20 includes a pair of fingers 24 that mates with two mating slots formed within the knuckle 30. It will be appreciated that, in other embodiments, the furcated terminal end of the support arm is not required. For example, a support arm may terminate with a single element that mates in a single slot in a corresponding knuckle. Alternatively, a support arm may terminate with three fingers and three mating slots may be provided in the corresponding knuckle. Use of two or more fingers on the ends of the support arms 20 may allow for reducing a width of an opening in the pivotal connection between the support arm 20 and the knuckle 30. In this regard, a total cross-sectional area of the support arm 20 is sufficient to withstand expected forces may be provided while ensuring small openings in the knuckle 30 to reduce the probability of pinching (e.g., a user's finger, clothing, headphone cord, etc. being partially disposed within a mating slot while the table is rotated).

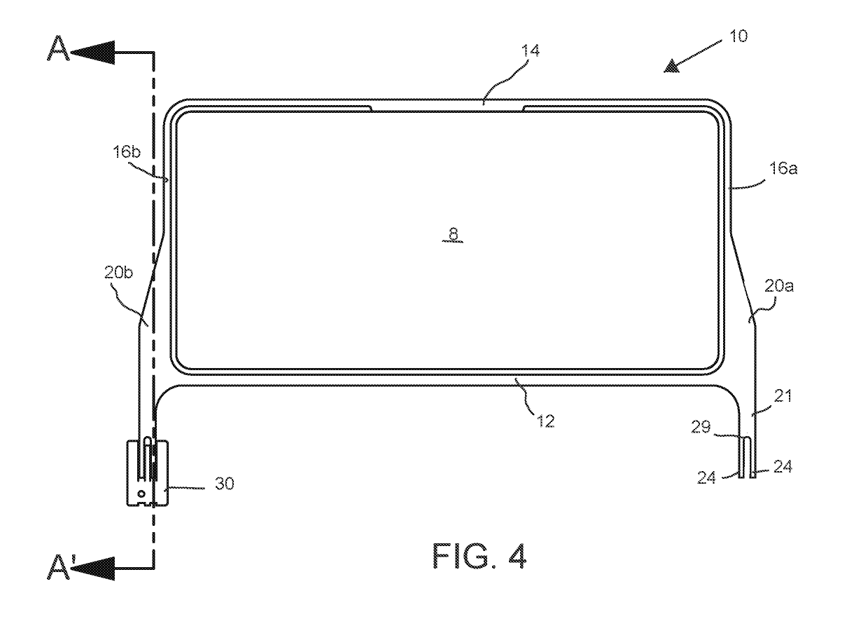

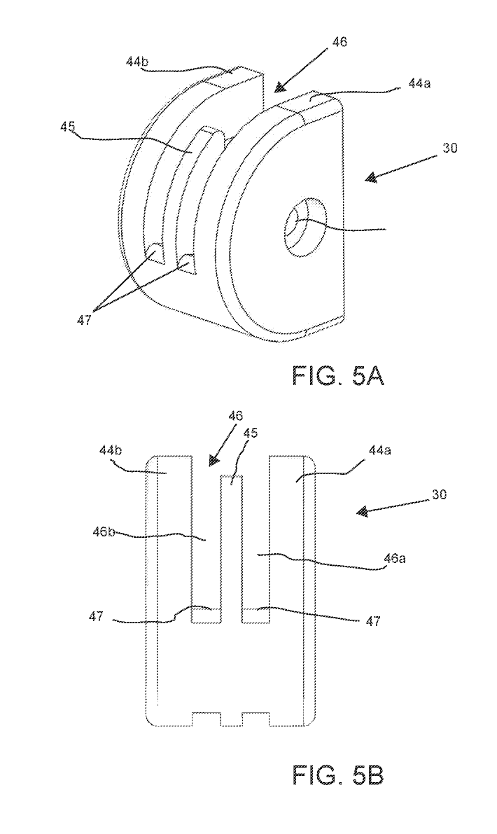

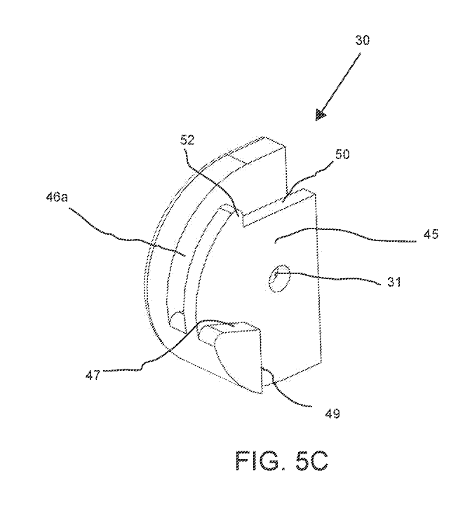

FIGS. 5A, 5B and 5C illustrate various views of the presented embodiment of the knuckle 30. More specifically, FIG. 5A shows a perspective view of the knuckle 30, FIG. 5B illustrates a front view of the knuckle 30, and FIG. 5C illustrates a partial cutaway of the knuckle 30. As shown, the knuckle 30 has first and second spaced sidewalls 44a and 44b (hereafter 44 unless specifically referenced) that define a slot 46 there between. In the illustrated embodiment, the knuckle further includes a central element or stud 45 disposed between the sidewalls 44. The central stud 45 divides the slot 46 into first and second slots 46a, 46b, which in the present embodiment are configured to receive the fingers on a free end of a support arm. A bore 31 extends through the sidewalls 44 and central stud 45. The bore 31 is sized to receive an axel pin (not shown). When the fingers of a free end of a support arm are disposed within the slots, such an axel pin passes through the bore 31 in the sidewalls 44 and central stud 45 and through elongated apertures (further discussed herein) in the fingers to pivotally couple the fingers 24 to the knuckle 30. Once pivotally coupled, the support arms are operative to move between the stowed and deployed positions described above. To allow the support arms to be disposed substantially vertical relative to the knuckle 30 (e.g., see FIG. 3A), a top end of the slot 46 is open. In order to support the support arm in a generally horizontal configuration (e.g., see FIG. 2D), a rearward end of the slot(s) include a support surface 47, which extends between the sidewalls 44. To permit the pivotal movement of the support arm, the support surface(s) 47 are disposed below and rearward of the bore 31 in the knuckle 30. In operation, the support surface 47 supports a lateral edge of the support arm when support arm is disposed in the horizontal position. Rearward edges of the sidewalls 44 may include one or more apertures (not shown) that allow the knuckle 30 to be secured (e.g., screwed, bolted, riveted adhered, etc.) to the aft surface of a passenger seat.

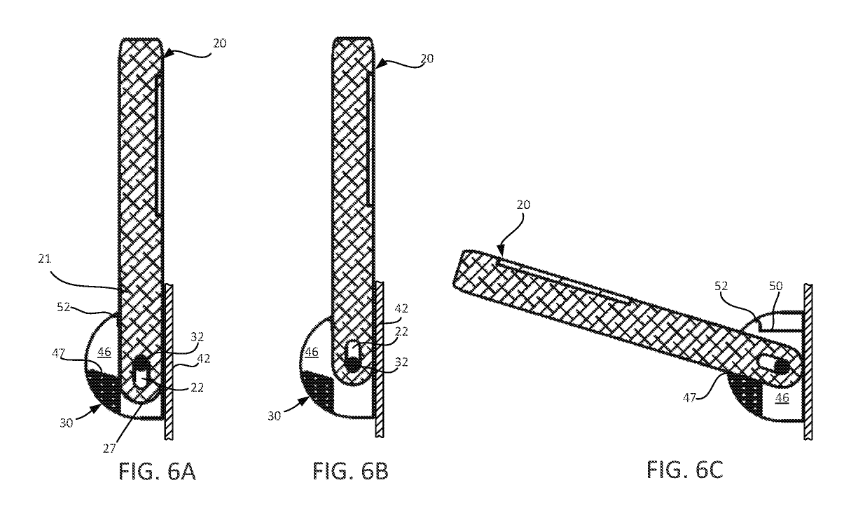

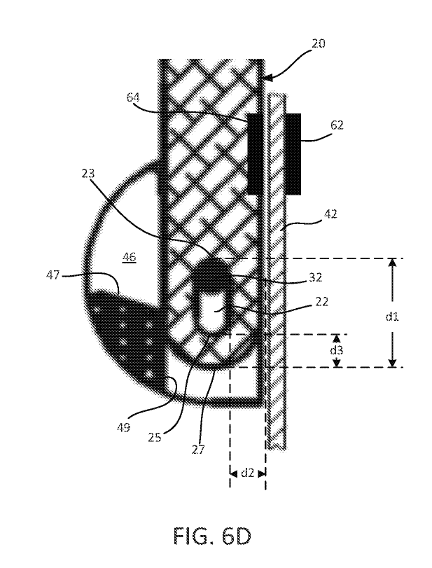

As best shown in FIG. 5C, the central stud 45 further includes a flat top edge 50 and a tab 52. In the present embodiment, the flat top edge 50 is sixed to receive the surface 29 of the support arm between the fingers 24. See FIG. 4. When the support arm is in a vertical orientation within the knuckle 30, the surface 29 between the fingers rest on this surface. In addition, the tab 52 is disposed rearward of the vertical support arm 20. See, e.g., FIG. 6A. When utilized, the tab 52 assists in preventing rotation of the support arm from the stowed position to the deployed position. However, it will be appreciated that the tab may be omitted in various embodiments.

FIGS. 6A-6D illustrates the internal cooperation of the support arms 20 with the knuckles 30 to provide the combined rotational movement and locking functions as taken along section line A-A′ of FIG. 4. As shown in FIGS. 6A-6D, an outer sidewall of the knuckle 30 is removed for an unobstructed view of the internal components. The combined rotational movement and locking function of the tray table assembly is enabled by the ability to axially advance and retract the support arms relative to the axel pin 32 of the knuckle 30. More specifically, each support arm has and elongated aperture 22 that passes through its free end portion 21. The axel pin 32 passes through the elongated aperture 22 to pivotally couple the support arm 20 to the knuckle 30. As shown in FIGS. 6A, 6B and 6D, the axel pin 32 is configured to move between a rearward or top end 23 of the elongated aperture 22 and a forward or bottom end 25 of the elongated aperture 22. See FIG. 6D. That is, the elongation of the aperture 22 allows the axel pin 32 to slide along the length of the aperture. More specifically, as the axel pin 32 is fixedly connected to the knuckle 30, the elongated aperture 22 allows that support arm 20 to move (e.g., axially) along the length of the aperture 22. When the support arm 20 is in a vertical position and the axel pin 32 is disposed at a rearward end 23 of the elongated aperture 22, the support arm 20 is locked in the vertical position. See FIG. 6A. When the support arm 20 is in a vertical position and the axel pin 32 is disposed at a forward end 25 of the elongated aperture 22, the support arm 20 is free to rotate about the axel pin 32.

As shown in FIG. 6A, the support arm is in a locked position and is prevented from rotating about the axel pin 32. In this arrangement, once the support arm is in a generally vertical position, the support arm 20 may be axially advanced into the knuckle 30 to position the axel pin 32 at the rearward or top end 23 of the elongated aperture 22. This disposes a terminal end 27 of the free end portion 21 of the support arm 20 into a forward portion of the slot 46 between the sidewalls of the knuckle 30 and in front of a forward edge 49 of the support surface 47. That is, the terminal end 27 of the support arm 20 is disposed in a lower portion of the slot 46 formed in the bottom of the knuckle 30 between a forward edge 49 of the support surface 47 and a slot end surface 42 at a forward edge of the knuckle 30. In the present embodiment, the slot end surface 42 at the forward edge of the knuckle 30 is formed by the back surface of the passenger seat to which the knuckle is connected. However, it will be appreciated that in other embodiments, the forward edge of the knuckle may have an integrally formed end surface. Alternatively, the slot end surface 42 may comprise, for example, a surface of a seatback recess, a plate (e.g., steel plate) installed on a seatback, etc.

The length of the free end portion of the support arm disposed within the knuckle 30 beyond the axel pin 32 prevents the support arm from rotating. That is, a first distance d1 between the axel pin 32 and the terminal end 27 of the support arm 20 is greater than a second distance d2 between the axel pin 32 and the slot end surface 42 (e.g., seatback). See FIG. 6D. In this regard, rotation of a rearward end of the support arm 20 and the attached tray table (not shown) is prevented by the recess end surface 42 and axel pin 32. That is, as shown in FIG. 6D, contact the recess end surface 42 prevent counterclockwise rotation of the terminal end of the support arm 20. Stated otherwise, in the stowed configuration, the distance from the axel pin 32 to the terminal end 27 of the support arm 20 exceeds the distance between the axel pin 32 and the seatback and there is insufficient space for the free end 27 to rotate around the axel pin 32, thus the tray table is secured in the stowed configuration. Further, the weight of the tray table assembly maintains the terminal end of the support arm within the slot. In this regard, no latching mechanism is required to maintain the tray table assembly in the locked/stowed configuration. Stated otherwise, gravity maintains the tray table in the stowed configuration.

FIG. 6B illustrates a cross-sectional view showing the tray table 10 in a retracted position as may be used when transitioning the tray table 10 from the deployed configuration to the stowed configuration and vice versa. In other words, this position may be utilized immediately before advancement of the terminal end 27 of support arm 20 into the receiving slot of the knuckle 30 or immediately after retraction of the support arm 20 from the receiving slot prior to rotation about axel pin 32. As shown, the support arm 20 is lifted until the axel pin 32 contacts the forward or bottom end of the elongated aperture 22. For example, when a user wishes to deploy the table, the user lifts that table 10, as discussed above, to axially advance the support arm 20 until the axel pin 32 is disposed at a bottom end of the elongated aperture 22. This removes the terminal end 27 of the support arm 20 from the lower portion of the slot and, if utilized, lifts the surface between the fingers of the free end of the support arm above the tab 52 on the central stud, thereby freeing the support arm from rotational interference of the slot end surface (seatback or other forward disposed obstruction). More specifically, a third distance d3 between the bottom end 25 of the elongated slot 22 to the terminal end 27 is equal to or less than the second distance d2 between the axel pin 32 and the slot end surface 42 (e.g., seatback). See FIG. 6D. Thus, the support arm is free to rotate about the axel pin 32.

Turning to FIG. 6C, once the free end 26 of support arm 20 is lifted free of the lower portion of the slot 46, the tray table 10 may be rotated into the deployed configuration. As the support arm 20 rotates, its lower surface engages the support surface 47. The support surface 47, in conjunction with the axel pin 32, supports the support arm 20 and thus the tray table 10 in a cantilevered position. Of note, while being shown as disposed at a non-level angle in FIG. 5C, the knuckle 30 typically is affixed to or in conjunction with an angled seatback (see e.g., FIGS. 2A-3B). In this regard, the tray table 10 is typically parallel to a floor surface of an aircraft or other passenger vehicle when deployed. In other words, the surfaces of the knuckles may be constructed to provide a desired orientation of the support arm 20 and connected tray table 10 based on the configuration of the seats to which they attach.

In a further embodiment, one or more magnets may be incorporated into the tray assembly to assist in maintaining the tray in the stowed position and/or to prevent the stowed tray from rattling. As shown in FIG. 6D a first magnet 62 may be affixed to or within the seat back 42. A second mating magnet 64 may be affixed to the support arm 20. When juxtaposed, these magnets 62, 64 may help secure the tray table in the stowed position.

The foregoing description has been presented for purposes of illustration and description. Furthermore, the description is not intended to limit the inventions and/or aspects of the inventions to the forms disclosed herein. Consequently, variations and modifications commensurate with the above teachings, and skill and knowledge of the relevant art, are within the scope of the presented inventions. The embodiments described hereinabove are further intended to explain best modes known of practicing the inventions and to enable others skilled in the art to utilize the inventions in such, or other embodiments and with various modifications required by the particular application(s) or use(s) of the presented inventions. It is intended that the appended claims be construed to include alternative embodiments to the extent permitted by the prior art.

What is claimed is:

1. A tray table assembly for use with a rearward surface of a seatback of a passenger seat, comprising:
a tray table having a generally planar surface;
at least one support arm attached to said tray table having a free end that extends beyond a forward edge of said tray table and an elongated aperture extending through said free end;
at least one bracket, configured for attachment to the aft surface of the passenger seat, having first and second spaced sidewalls defining a slot there between, wherein a portion of said free end of said support arm is sized for disposition within said slot;
an axel pin extending across said slot between said first and second sidewalls and passing through said elongated aperture pivotally connecting said support arm to said bracket, wherein said support arm is operative to move between a generally vertical orientation where said tray table is in stowed position juxtaposed relative to the aft surface of the passenger seat and a generally horizontal orientation where said tray table is in a deployed position; and
wherein in said generally vertical orientation, positioning said axel pin at a rearward end of said elongated aperture prevents rotation of said support arm to said generally horizontal orientation while positioning said axel pin at a forward end of said elongated aperture permits rotation of said support arm to said generally horizontal orientation.

2. The assembly of claim 1, wherein, when said support arm is in said generally vertical orientation and said axel pin is positioned at a rearward end of said elongated aperture, said axel pin and a surface extending across a forward end of said slot prevent rotation of said support arm from said generally vertical orientation to said generally horizontal orientation.

3. The assembly of claim 1, wherein said rearward end of said elongated aperture is a first distance d₁ from a terminal end of said support arm and said axel pin is a second distance d₂ from said surface extending across said forward end of said slot, wherein said first distance d₁ is greater than said second distance d₂.

4. The assembly of claim 3, wherein said forward end of said elongated aperture is a third distance d₃ from said terminal end of said support arm, wherein said third distance d₃ is less than or equal to said second distance d₂.

5. The assembly of claim 2, wherein said surface extending across a forward end of said slot comprises one of:
a portion of the aft surface of the passenger seat; and
an endwall of said bracket extending between said first and second sidewalls.

6. The assembly of claim 1, further comprising a support surface extending across said slot between said first and second sidewalls, wherein said support surface disposed below and rearward of said axel pin.

7. The assembly of claim 6, wherein, when said support arm is in said generally horizontal orientation, a bottom edge surface of said free end of said support arm is supported by said support surface, wherein said support surface and said axel pin maintain said tray table in said deployed position.

8. The assembly of claim 1, wherein said free end further comprises first and second fingers, wherein said first and second fingers include first and second elongated apertures, respectively and wherein said axel pin passes through said first and second elongated apertures.

9. The assembly of claim 8, wherein said bracket further comprises a stud disposed between said first and second spaced sidewalls wherein said stud divides said slot into first and second slots, wherein said first and second slots are sized to receive said first and second fingers, respectively.

10. A tray table assembly, comprising:
a tray table having a working surface;
a first support arm having a proximal end operatively attached to the tray table; and
a first knuckle comprising:
opposing first and second sidewalls;
at least one slot disposed between said first and second side walls and sized to receive a free end of said first support arm, wherein said free end comprises an elongated aperture; and
a first axel pin, extending between said first and second sidewalls and through said elongated aperture, wherein said first axel pin is configured to pivotally connect the first support arm to said first knuckle, and wherein said elongated aperture is configured to allow the first support arm to slide in relation to the first axel pin.

11. The tray table assembly of claim 10, wherein the slot comprises two slots separated by a stud and the free end comprises two fingers each having an elongated aperture such that the axel pin is disposed through the stud and the elongated apertures of the two fingers.

12. The tray table assembly of claim 11, wherein the slot comprises a support surface having a horizontal edge and a vertical edge, wherein the horizontal edge is configured to engage an edge portion of the first support arm when the support arm is in a horizontal position.

13. The tray table assembly of claim 12, wherein the knuckle further comprises a receiving slot configured to restrain rotational movement of the first support arm when the tray table assembly is disposed in a stowed configuration in which the working surface is disposed parallel to a rearward surface of a seatback of a passenger seat to which the first knuckle is attached and said first axel pin is disposed at a proximal end of the elongated aperture.

14. The tray table assembly of claim 10, wherein the elongated aperture extends longitudinally along the first support arm along a long axis of the support arm.

15. The tray table assembly of claim 10, further comprising:
a second support arm having a proximal end operatively attached to the tray table; and
a second knuckle comprising:
opposing first and second side walls;
a slot disposed between said first and second side walls and sized to receive at least one corresponding free end of said second support arm, wherein said at least free end comprises an elongated aperture; and
a second axel pin, extending between said first and second outer walls and through said elongated aperture, wherein said second axel pin is configured to pivotally connect the second support arm to said second knuckle, and wherein said elongated aperture is configured to allow the second support arm to slide in relation to the second axel pin.

16. The tray table assembly of claim 10, further comprising:
a passenger seat having a seatback with a forward surface and a rearward surface, said rearward surface comprising a recess configured for receipt of at least a portion of the tray table, wherein said first knuckle is attached to the rearward.
